(19) United States
(12) Patent Application Publication
(10) Pub. No.: US 2010/0076779 A1
(43) Pub. Date: Mar. 25, 2010

(54) METHODS AND SYSTEMS FOR RECORDING AND MANAGING MANUFACTURING CAPACITY ATTRIBUTES

(76) Inventor: Daniel Thomas Hamling, Solana Beach, CA (US)

Correspondence Address: Dan Hamling, 450 Santa Alicia, Solana Beach, CA, 92075, US

(21) Appl. No.: 12/554,916

(22) Filed: Sep. 6, 2009

Related U.S. Application Data
(60) Provisional application No. 61/094,937, filed on Sep. 7, 2008.

(51) Int. Cl. G06F 17/30

(52) U.S. Cl. 705/1; 707/E17.014

(57) ABSTRACT

The present invention comprises methods and systems that provide the ability to record and manage manufacturing capacity attributes that describe the capacity at its lowest level of configurability—supporting the specification, planning, matching, and trading of the capacity. This is generally accomplished by first establishing a common data model that can store relational datasets of attributes for the various types of requirements and equipment, with accuracy and precision down to their lowest allowed levels of configurability. The present invention also provides a set of user interfaces (Uls) that provide a means to browse, filter, search, view, edit, group, report, and communicate the attribute datasets. Each dataset can also be originated or updated through an ability to import attribute information from manufacturing equipment, attribute files, other database systems, and the like. Furthermore, the present invention also provides the foundation for enabling other capacity management functions such as planning, matching, and trading of capacity

### FIELD OF INVENTION

The invention is related to methods and systems for managing manufacturing capacity, and more particularly to methods and systems that provide the ability to record and manage all attributes of manufacturing capacity necessary for capacity planning, usage, and trading optimization.

### BACKGROUND OF INVENTION

The complexities and uncertainties associated with the manufacturing of semiconductor products (“chips”) requires that some level of testing be performed on each chip before being shipped to customers. The extent of testing can range from sample testing for chips deploying straightforward designs and mature manufacturing processes, to several stages of lengthy, fully-functional, multi-temperature testing for chips using the latest technologies.

The automatic test equipment (ATE) used to perform the tests on semiconductor chips provide the stimulus to the chip, as well as capture and process the response from the chip, all under computer control. Since ATE must be able to source and capture many channels of the latest high-speed, smart-power, and high-precision signals, the ATE business model requires significant investments in research and development, applications engineering, and other support functions. The current industry average selling price for ATE is therefore in the range of $US0.5 million to $US1.5 million.

In order to manage the overall cost of test, ATE will typically be configured to have only the channels and capability needed to test a particular chip, making the manufacturing capacity provided by the ATE dedicated to a given chip, or at best, a chip family. Each ATE supplier, too, has a different architecture and set of channel attributes, adding another dimension of complexity and incompatibility to the test capacity. In addition, each chip has a unique list of required tests, making the cycle time through the test process chip-dependent. Furthermore, each chip requires a specific combination of peripheral components and equipment (e.g. interface fixtures and sockets, handling equipment and kits, etc.) that together with the ATE complete a full “test cell” of capacity. The many cells of semiconductor test capacity required today are therefore very diverse and non-uniform.

This variability makes it difficult for test providers to optimize the utilization of costly test assets and thus maximize their return on investment (ROI)—reducing the economic profits of not only the test provider, but also that of the test specifier and test equipment supplier. This issue is even more of a problem for the test subcontractor, whose founding business model relies on the efficient aggregation of test demand across a diverse set of test specifiers and their chips. The typically-cited one-third of test capacity that is unutilized accounts for an estimated US$1.8 billion of annual depreciation costs, a significant economic burden on the entire semiconductor test value chain.

The landscape of solutions related to semiconductor test generally addresses both low and high levels of operations abstraction, but leaves a conspicuous gap at the test capacity planning level. At the low level, the solutions ignore the chip's test capacity requirements and therefore cannot perform any of the test capacity planning functions needed to significantly improve ROI. Just above the low end are tools focused on overall equipment efficiency (OEE) which lack the demand aggregation and configuration management capabilities required of a value-adding test capacity planning solution. At the high level, well-known supply chain management, demand management, and business intelligence offerings treat test capacity simply as a “black box,” precluding any useful planning functionality that accounts for the non-uniformity of test capacity. At the test capacity management level are numerous, incompatible, obvious and rudimentary spreadsheet solutions that severely lack the detailed modeling sophistication and resulting precision and accuracy that are needed today.

A vital element that is missing from the prior art is an ability to record and store test capacity attributes with accuracy and precision to the lowest level of equipment configurability. Current solutions typically store only a high level description of the test capacity requirements or inventory, with the needed attribute details spread across an array of non-standard files and locations. Many inefficient and expensive iterations involving several information sources and many stakeholders is therefore required to achieve a complete specification of manufacturing test capacity. Such fully specified test capacity requirements and inventory is required throughout the test capacity planning, matching, and trading processes.

Thus, a solution is needed that enables sophisticated recording and managing of manufacturing capacity attributes, like those which are used for testing of semiconductor chips.

### SUMMARY OF INVENTION

The present invention delivers the ability to record and manage manufacturing capacity attributes.

In particular, the present invention comprises methods and systems that provide the ability to record and manage manufacturing capacity attributes that describe the capacity at its lowest level of configurability—supporting the specification, planning, matching, and trading of the capacity. This is generally accomplished by first establishing a common data model that can store relational datasets of attributes for the various types of requirements and equipment, with accuracy and precision down to their lowest allowed levels of configurability. The present invention also provides a set of user interfaces (UIs) that provide a means to browse, filter, search, view, edit, group, report, and communicate the attribute datasets. Each dataset can also be originated or updated through an ability to import attribute information from manufacturing equipment, attribute files, other database systems, and the like. Furthermore, the present invention also provides the foundation for enabling other capacity management functions such as planning, matching, and trading of capacity.

### BRIEF DESCRIPTION OF DRAWINGS OF INVENTION

The accompanying drawings, which are incorporated in, and constitute a part of, this specification illustrate an embodiment of the invention and, together with the description, serve to explain the advantages and principles of the invention. In the drawings,

FIG. 1 illustrates a block diagram of the operating environment of the present invention;

FIG. 2 illustrates a block diagram of the server of the present invention;

FIG. 3 illustrates the database entity relationship diagram of the present invention;

FIG. 4 illustrates the main agents of the present invention;

FIG. 5-6 illustrate the methods of the agents of the present invention;

FIG. 7 illustrates examples of the user interface for the methods of the present invention.

### DETAILED DESCRIPTION OF PREFERRED EMBODIMENT OF INVENTION

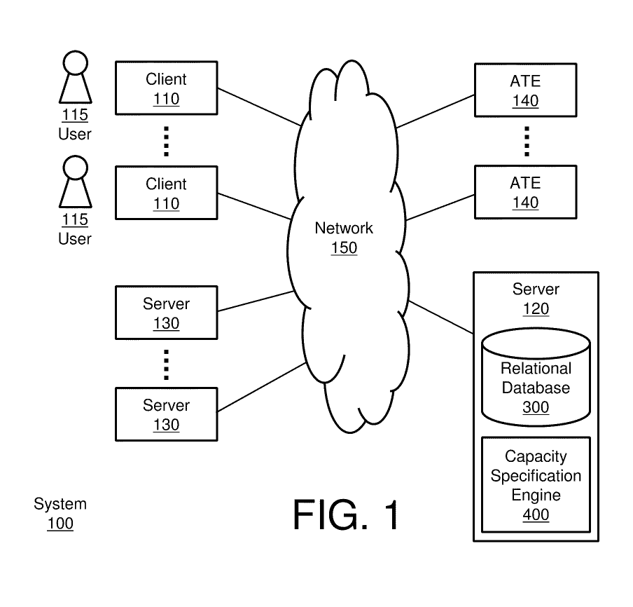

FIGS. 1 to 7 represent various aspects of the preferred embodiment of methods and systems that provide the ability to record and manage manufacturing capacity attributes that describe the capacity at its lowest level of configurability—supporting the specification, planning, matching, and trading of the capacity.

### System Architecture

FIG. 1 illustrates a system 100 in which methods consistent with the present invention may be implemented. System 100 includes multiple client devices 110, multiple servers 120 and 130, and multiple automatic test equipment (ATE) systems 140, all connected via a network 150. Network 150 shown comprises the Internet, but may also comprise other networks, such as an intranet or direct connections. Two client devices 110, one server 120, two servers 130, and two ATE systems 140 are shown as connected to network 150 for simplicity. Alternative embodiments may have different quantities of devices, servers, and systems than that shown. Also, client device 110 may perform the functions of server 120 or 130, and server 120 or 130 may perform the functions of client device 110. Moreover, methods according to the present invention may even operate within a single client device 110, server 120 or 130, or ATE system 140.

Through client devices 110, users 115 can communicate over network 150 with each other and with other devices and systems coupled to network 150. Examples of client devices 110 include mainframes, minicomputers, personal computers, laptops, digital assistants, personal digital assistants, cellular phones, mobile phones, smart phones, pagers, digital tablets, laptop computers, Internet appliances, or the like, capable of connecting to network 150. Client devices 110 transmit data over network 150 or receive data from network 150 via a wired, wireless, or optical connection.

Servers 120 and 130 include one or more types of computer systems, such as a mainframe, minicomputer, or personal computer, capable of communicating over network 150 with each other and with other devices and systems coupled to network 150. In other embodiments, servers 120 and 130 may include mechanisms for directly connecting to one or more client devices 110 or ATE systems 140. Servers 120 and 130 may also comprise multiple and/or distributed devices. Servers 120 and 130 transmit data over network 150 or receive data from the network 150 via a wired, wireless, or optical connection.

ATE systems 140 include one or more types of computer systems, such as a mainframe, minicomputer, or personal computer, capable of controlling the ATE operation and communicating over network 150 with each other and with other devices and systems coupled to network 150. ATE systems 140 transmit data over network 150 or receive data from the network 150 via a wired, wireless, or optical connection.

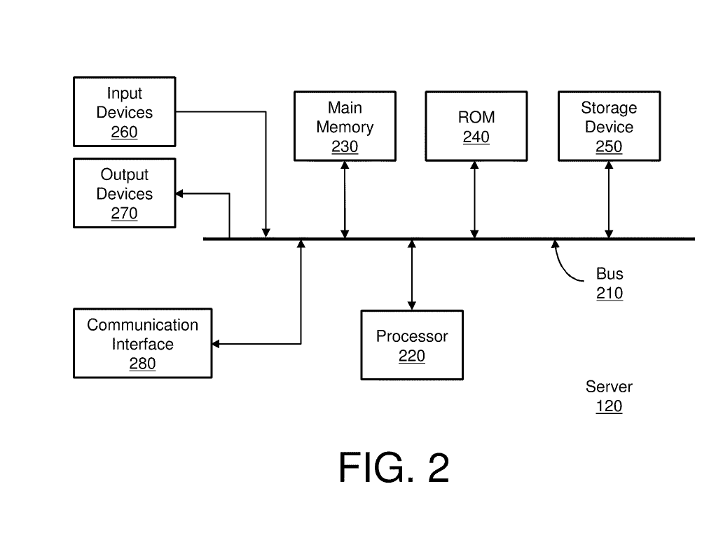

FIG. 2 illustrates the block diagram of server 120 consistent with the present invention. Server 120 includes a bus 210, a processor 220, a main memory 230, a read only memory (ROM) 240, a storage device 250, an input device 260, an output device 270, and a communication interface 280.

Bus 210 includes one or more conventional buses that permit communication among the components of server 120. Processor 220 includes any type of conventional processor or microprocessor that interprets and executes instructions. Main memory 230 includes a random access memory (RAM) or another type of dynamic storage device that stores information and instructions for execution by processor 220. ROM 240 includes a conventional ROM device or another type of static storage device that stores static information and instructions for use by processor 220. Storage device 250 includes a magnetic and/or optical recording medium and its corresponding drive.

Input device 260 includes one or more conventional mechanisms that permit information to be delivered to server 120, such as a keyboard, a mouse, a pen, voice recognition and/or biometric mechanisms, and the like. Output device 270 includes one or more conventional mechanisms that output information, such as a display, a printer, a speaker, and the like. Communication interface 280 includes any transceiver-like mechanism that enables server 120 to communicate with other devices and/or systems, directly and/or via a network, such as network 150.

Client devices 110, servers 130, and ATE systems 140 have computing architectures similar to that described above in reference to FIG. 2 for server 120. In the preferred embodiment, access to data stored on servers 130 and ATE systems 140 are most vital to implementing the methods of the present invention. For example, storage device 250 of servers 130 may contain enterprise planning, business intelligence, and chip test requirements data accessible by client devices 110 and server 120 for use in the preferred embodiment of the present invention. Similarly, storage device 250 of ATE systems 140 may contain equipment configuration, operational status, and chip test requirements data accessible by client devices 110 and server 120 for use in the preferred embodiment of the present invention.

### Relational Database

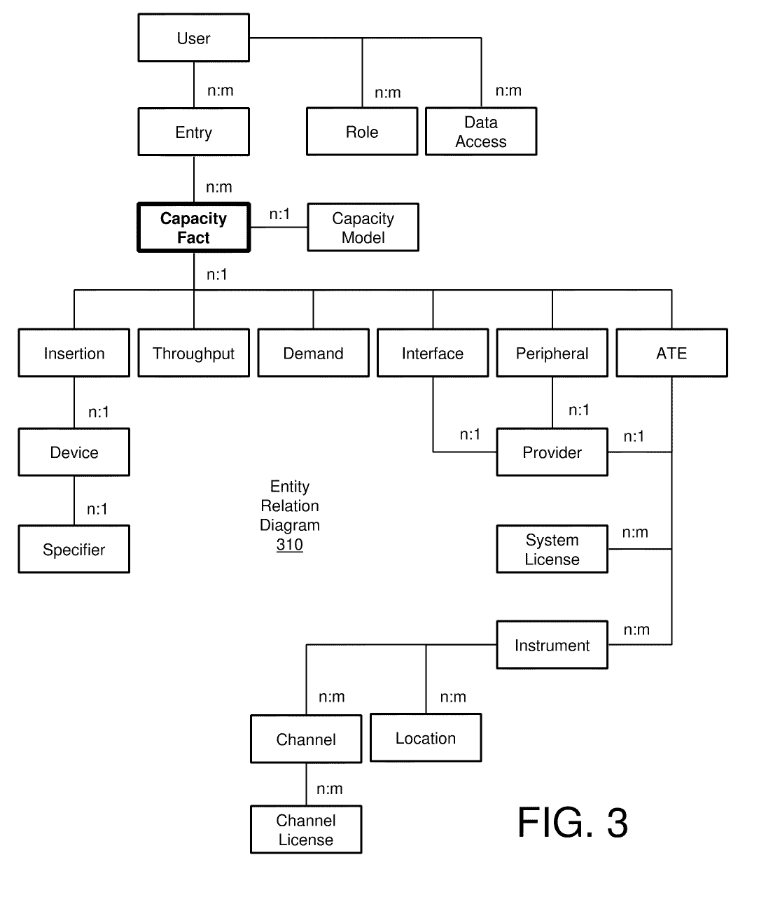

To facilitate recording and management, capacity attributes will typically be stored in a relational database 300 on storage device 250 of server 120, as shown in FIG. 1. Database 300 could also be contained on other such storage devices accessible through network 150. FIG. 3 depicts the entity relationship diagram 310 of relational database 300 for the present invention. Each box shown in the figure is an “entity” or a logical collection of attributes. The physical counterpart of an entity is a database table. The lines connecting the boxes indicate some type of relationship between the entities. As shown, the “User” entity has a relationship with the “Entity”, “Role”, and “Data Access” entities. The “n:m” designation between the User entity and the Role entity, for example, indicates that each User may have more than one Role, and more than one User may have the same Role. The three levels of “n:m” child entities below the “ATE” entity allow the test system attributes to be described at their lowest level of configurability.

The “Capacity Fact” entity is highlighted since it is the parent entity for collecting attributes related to “Insertion”, “Throughput”, “Demand”, “Interface”, “Peripheral”, and “ATE.” A new and unique Capacity Fact entity will be created for each period of time throughout which the attributes in each of the aforementioned child entities is constant. Thus, the “n:1” designation between the Capacity Fact entity and each child entity indicates that each Capacity Fact will have only one type of each child entity, but each type of child entity may be associated with more than one Capacity Fact. For example, an attribute in the Demand entity may be different among two unique Capacity Facts, but all other attributes in Demand or any other child entity may be the same among the two Capacity Facts. With this data structure, capacity attributes will be recorded into datasets that are unique yet constant for a given time “slice,” allowing for the efficient specification, planning, matching, and trading of test capacity.

### Agents and Methods

Consistent with the present invention, server 120 performs certain capacity attribute recording and management operations via the capacity specification engine 400. Server 120 performs these operations in response to processor 220 executing software instructions contained in a computer-readable medium, such as main memory 230. A computer-readable medium may be defined as one or more memory devices and/or carrier waves. The software instructions are read into main memory 230 from another computer-readable medium, such as data storage device 250, or from another device via communication interface 280. The software instructions contained in main memory 230 causes processor 220 to perform capacity attribute recording and management operations described below. Alternatively, hardwired circuitry may be used in place of or in combination with software instructions to implement processes consistent with the present invention. Thus, the present invention is not limited to any specific combination of hardware circuitry and software.

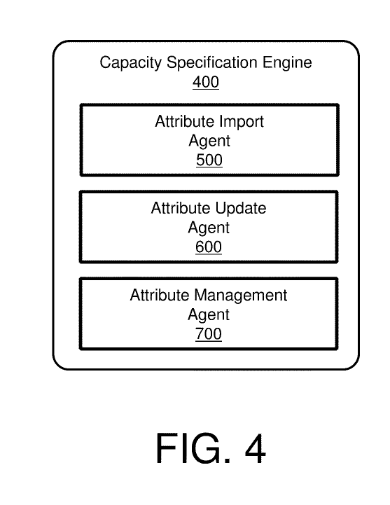

FIG. 4 illustrates capacity specification engine 400 comprised of software instructions that are collectively grouped into agents. Other software instruction groupings include services, applications, programs, procedures, classes, objects, subroutines, functions, web pages, scripts, queries, and the like. The agents shown include an attribute import agent 500, an attribute update agent 600, and an attribute management agent 700. Capacity specification engine 400 performs capacity attribute recording and management operations generally initiated by users 115 through client devices 110. Some operations may also be performed automatically on server 120 without any intervention by users 115. Such automatic operations will typically include the transmittal and retrieval of data from storage devices 250 of both servers 130 and ATE systems 140 over network 150.

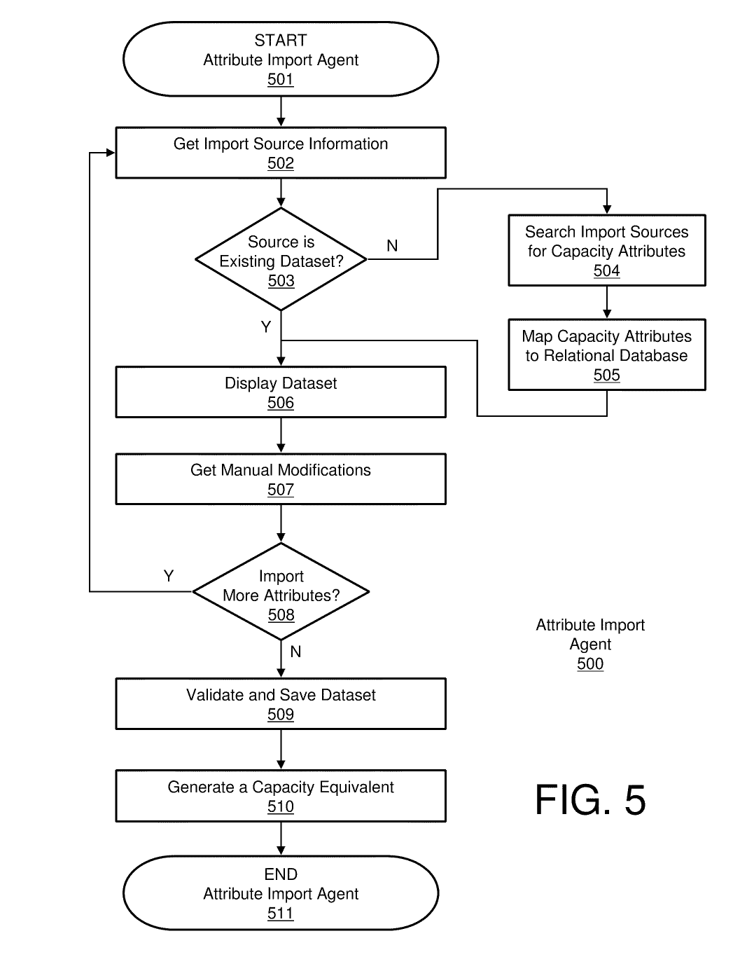

FIG. 5 illustrates the method of attribute import agent 500, which performs the extraction of detailed capacity attributes from various non-standard data sources such as ATE configuration and license files, ATE test programs, and the like. The first step in agent 500 is to get import source information 502. This is done via user 115 input at client device 110 (e.g. for new entries) or the passing of parameters and data from a calling procedure or agent (e.g. for existing entries). The import source information will typically comprise file types, names, and directory locations. Agent 500 will then check if source is existing dataset 503. If yes, agent 500 will simply display dataset 506 to be used as a starting point for a new dataset. If the source is not an existing dataset, agent 500 will search import sources for capacity attributes 504. In this step, agent 500 will locate and scan the source files or databases specified in get import source information 502 for relevant attributes to import. Agent 500 will then map capacity attributes to relational database 505 by writing the attributes discovered in step 504 to the appropriate fields in relational database 300 that has a structure similar to entity relation diagram 310. The knowledge and business logic embedded in steps 504 and 505 comprise a majority of the innovation and novelty of the present invention. Following the completion of step 505, agent 500 will display dataset 506. Agent 500 will then get manual modifications 507 to dataset typically via user 115 input at client device 110. If there is a need to import more attributes 508, for example from a different set of import sources, steps 502-507 are repeated. When there is no more need to import more attributes 508, agent 500 will validate and save dataset 509 by ensuring that the new dataset is unique, includes all required fields, and contains valid information in each field. As a final step, agent 500 will generate a capacity equivalent 510 of the saved dataset, creating a new dataset stored on relational database 300 according to entity relation diagram 310 and having the same valid period as the originating dataset. The dataset generated by step 510 basically expresses time-phased chip test requirements, test equipment inventory, and groupings of such, in common operational units of capacity to allow for efficient aggregation and optimization. A dataset describing the test requirements for a given chip, for example, will have an accompanying dataset from step 510 that will be generated by convolving the chip's unit demand with its test capacity requirements per unit, using a capacity equivalent model associated with that chip. The resulting dataset describes the detailed test capacity requirements for the chip in terms of attributes common to test capacity providers. The capacity equivalent data includes not only functional and temporal configuration attributes of the ATE but also functional and temporal attributes of related test cell equipment and consumables—such as material handlers, probers, and device interface boards—as well as other functional and temporal attributes such as those describing the disposition and state of the available test capacity.

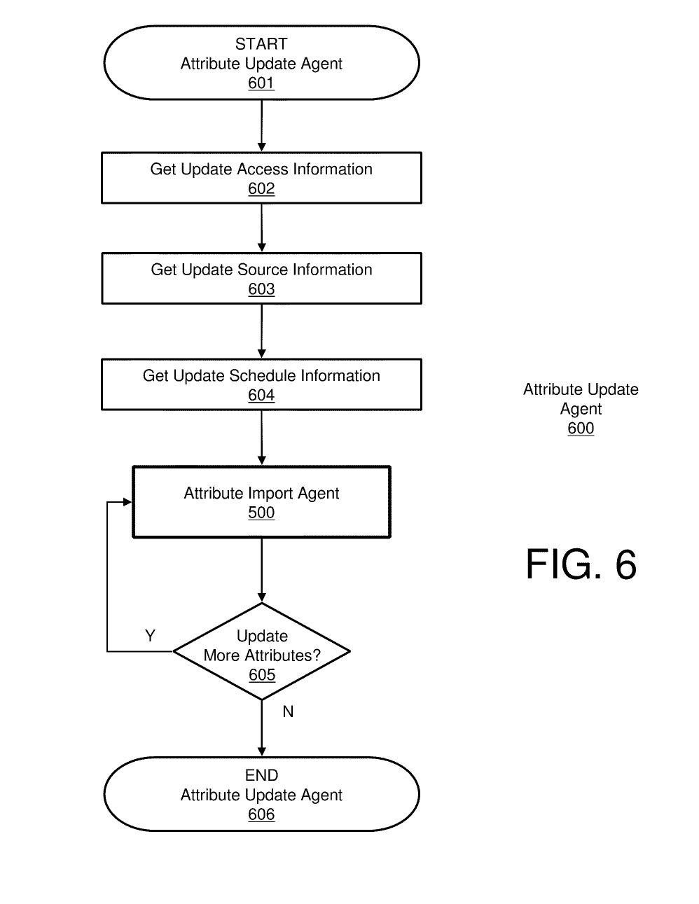

FIG. 6 illustrates the method of attribute update agent 600, which updates existing datasets with new information through the extraction of detailed capacity attributes from various non-standard data sources such as ATE configuration and license files, ATE test programs, and the like. Agent 600 is vital in keeping certain dynamic capacity attributes up to date, typically through a pre-set automatic update schedule. The first step in agent 600 is to get update access information 602. The update access information will typically comprise network security and authentication information such as user names, passwords, internet protocol addresses, routing information, and the like, needed to access various data sources. Agent 600 will then get update source information 603. The update source information will typically comprise file types, names, and directory locations. Agent 600 will then get update schedule information 604 typically comprising information regarding the timing of the execution of agent 600 for a given dataset such as update period, execution time of day, specific attributes to be updated, and the like. Information for steps 602-604 are provided via user 115 input at client device 110 or the passing of parameters and data from a calling procedure or agent. Once agent 600 has the required information from steps 602-604, attribute import agent 500 is called and executed to perform the import function for all datasets scheduled to be updated. As a final step, agent 600 will decide if it needs to update more attributes 605 and will repeat the call of agent 500 if necessary. Multiple or iterative calls of agent 500 may be necessary if agent 600 is unable to perform simultaneous updates for any reason.

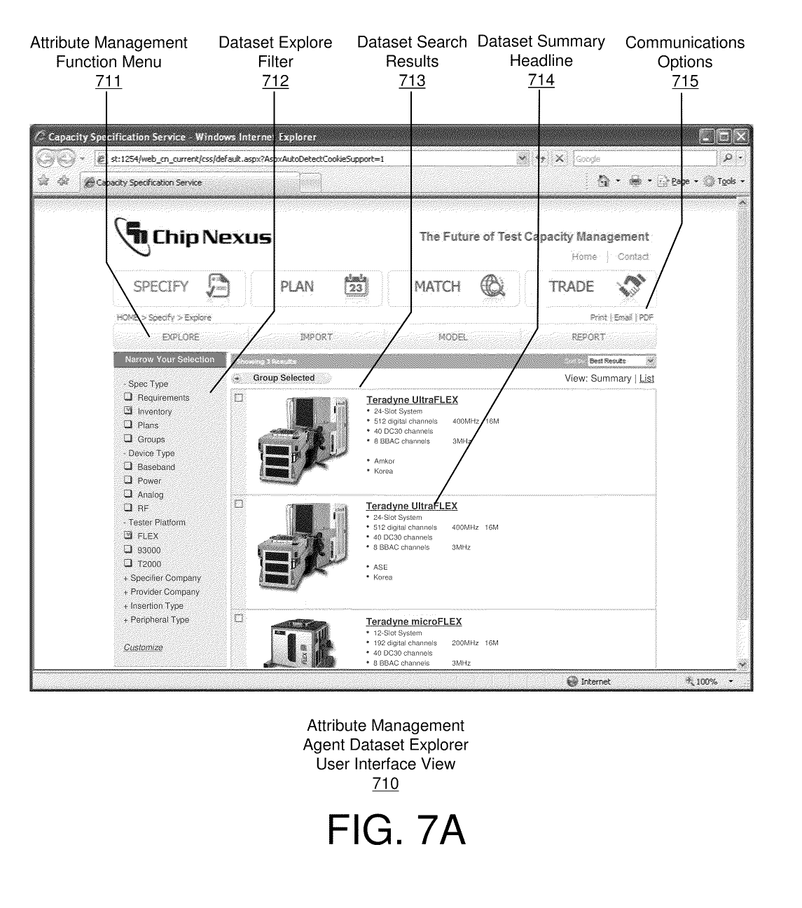

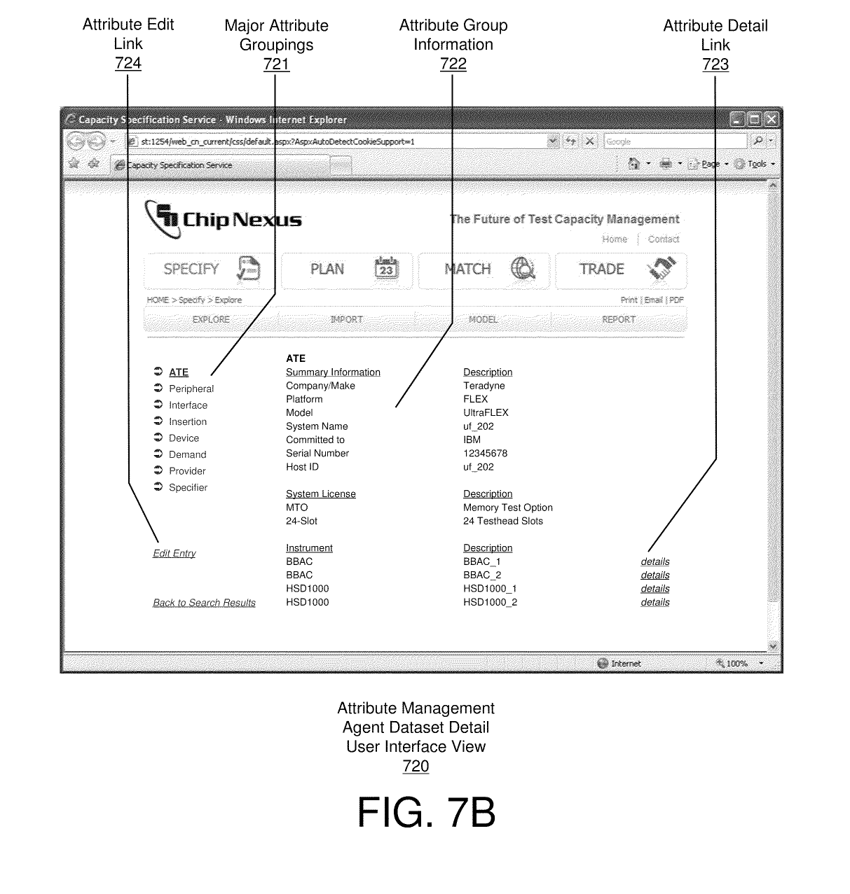

As shown in FIG. 4, capacity specification engine also has an attribute management agent 700. Agent 700 has many functions and features, primarily allowing user 115 to browse, filter, search, view, edit, group, report, communicate, etc. attribute datasets. Agent 700 essentially provides the user interface layer that makes engine 400 and ultimately system 100 a valuable and productive software tool. In one exemplary embodiment, an attribute management agent dataset expolorer user interface view 710 like that in FIG. 7A may be provided. With view 710 as well as other views related to engine 400, user 115 can select among the key actions in an attribute management function menu 711: “Explore”, “Import”, “Model”, and “Report”. The Import item in menu 711 provides views that allow the setup and execution of agents 500 and 600. The Model item in menu 711 provides views that allow user 115 to create and modify capacity equivalent model entities that can be included in datasets stored on relational database 300 according to entity relation diagram 310. Finally, the Report item in menu 711 provides views that allow user 115 to create and communicate reports of single or multiple datasets.

The Explore function provides a view such as view 710 that allows the management of all datasets accessible to user 115. In particular, user 115 can use dataset explore filter 712 to select attributes that are to be included in the dataset search results 713 listed under “Showing 3 Results” in view 710. The results 713 are high level summaries of the attribute datasets that match the selected attributes in filter 712 and are accessible to user 115. These specification datasets could be test specifier requirements, test provider inventory, test specifier plans, or test provider plans, as well as groups of multiple datasets of each aforementioned type. The details of each dataset can be viewed by selecting the dataset summary headline 714. Selecting one of the communications options 715 allows user 115 to “Print”, “Email”, or create a “PDF” of results 713. The email option, in particular, provides a hyperlink to a view similar to view 710 that allows both users and non-users to view results 713. Other forms of communication are also possible.

As mentioned, selecting headline 714 in results 713 will display the detailed attributes of the selected dataset. FIG. 7B shows the attribute management agent dataset detail user interface view 720. In view 720, user 115 will select from the major attribute groupings 721 to display the attribute group information 722. Information 722 reveals the lowest level of detail available for the selected dataset. Since the attributes for a given group can be numerous, additional levels of detail can be displayed by selecting an attribute detail link 723. For example, for the “ATE” group shown in view 720, additional attributes for instrument “BBAC_{—}1” of type “BBAC” can be found by selecting the link 723 labeled “details.” Such detailed attributes may include instrument location, channel descriptions and locations, and channel licensing. User 115 can also launch an editing view similar to view 720 by selecting the attribute edit link 724. The selected dataset can then be manually edited and the modified dataset saved. User 115 can return to the explorer view 710 by selecting Explore in menu 711 or clicking the browser's “Back” button. A broad range of communication options like those shown in view 710 are also possible.

### General

While the description above of the present invention contains many specificities, these should not be construed as limitations on the scope of the invention, but rather as an exemplification of one preferred embodiment thereof. Accordingly, other modifications and variations may be possible in light of the above teachings. The embodiment above was chosen and described in order to best explain the principles of the invention and its practical application to thereby enable others skilled in the art to best utilize the invention in various embodiments and various modifications as are suited to the particular use contemplated. The appended claims and their legal equivalents are intended to determine the scope of the present invention which may include other alternative embodiments except insofar as limited by the prior art.

What is claimed is:

1. A method of recording and managing manufacturing capacity attributes, said method comprising the steps of: a) receiving information describing said capacity attributes;
b) storing said information; and c) managing said information; where managing includes but is not limited to some combination of browsing, filtering, searching, viewing, editing, grouping, reporting, and communicating said information.

2. The method of claim 1 wherein said information is acquired through a combination of user input and automatic retrieval from a plurality of data input and storage means.

3. The method of claim 1 wherein said capacity attributes include attributes that describe the configuration of each independent component comprising said capacity at the lowest level of configurability of said component.

4. The method of claim 1 wherein said capacity attributes include attributes that describe the operational support and performance of said capacity, including but not limited to attributes describing labor requirements, operational metrics, and financial metrics.

5. The method of claim 1 wherein said capacity attributes include attributes that are time-dependent, including but not limited to attributes describing time-dependent configuration or location changes.

6. The method of claim 1 wherein said storing utilizes a database that can store relational datasets of said attributes, whereby the storage of said attributes is optimized for said managing.

7. The method of claim 1 wherein said storing further comprises the step of validating the accuracy of said information describing said attributes.

8. The method of claim 1 wherein said storing further comprises the step of generating and storing a time-phased capacity equivalent of each logical group of said capacity attributes, whereby said equivalent expressed in common operational units of capacity optimize capacity management functions such as planning, matching, and trading of capacity.

9. The method of claim 1 wherein said managing further comprises the step of providing a user interface, whereby the user can efficiently browse, filter, search, view, edit, group, report, and communicate said information.
